(19) United States
(12) Patent Application Publication
(10) Pub. No.: US 2017/0009918 A1
(43) Pub. Date: Jan. 12, 2017

(54) GASKET WITH COMPRESSION AND ROTATION CONTROL

(71) Applicant: William J. Koves, Elgin, IL (US)

(72) Inventor: William J. Koves, Elgin, IL (US)

(21) Appl. No.: 15/152,025

(22) Filed: May 11, 2016

Related U.S. Application Data
(63) Continuation-in-part of application No. 14/324,220, filed on Jul. 6, 2014, now abandoned.

(51) Int. Cl. F16L 23/20; F16J 15/08

(52) U.S. Cl. CPC F16L 23/20; F16J 15/0887

(57) ABSTRACT

A multifunctional gasket with compression and rotation control comprises annular sealing element(s) with specific stiffness, geometry, tightness and compressibility properties and uniquely shaped compression element(s) with variable thickness and specific mechanical properties. The gasket is designed to seal under static and dynamic fluid pressure loading for a wide range of sizes and with severe thermal differential temperatures and static and dynamic external loads. This gasket is able to significantly increase the pressure rating for leakage, ability to resist external forces and moments, resistance to thermal differentials and operating reliability of flanges in accordance with published standards, as well as enable the more efficient design of special flanges for demanding operating conditions. The gasket design also allows for easier, faster and more uniform assembly of the joint.

### CROSS REFERENCE TO RELATED APPLICATIONS

This application is a continuation-in-part of U.S. application Ser. No. 14/324,220 filed Jul. 6, 2014, the teachings of which are incorporated herein by reference.

### FIELD OF THE INVENTION

The invention described herein is in the field of fluid containment at clamped conduit or chamber flanges. In a general form the invention relates to joining conduits or chambers, each defining a flange body about an open end thereof, by a sealing structure clamped between opposing flange bodies defined at the end of the conduits or chambers. These flanges are provided to prevent fluid leakage into or out of the chambers or conduit under temperature conditions, internal pressure loads, and/or external forces. In more specific form this invention provides a sealing structure, typically, in the form of a gasket, which is adapted when clamped between flange bodies, typically in the form of flanges, to seal the gap between the flange bodies around a chamber or conduit jointly defined by the flange bodies as the space there between. Hereafter when the term “flanges” is used it is referring to the typical application and is not intended to exclude other structural types of connection bodies. The sealing structure of this invention may be used, for example, for sealing the gap between flanges at the ends of pipes, pipe to nozzle flange on vessels, or the body flanges on heat exchangers.

### DESCRIPTION OF THE PRIOR ART

U.S. Pat. No. 5,823,542 ('542 Patent), which issued to Owen, discloses a spiral wound gasket. The '542 Patent describes a spiral wound gasket able to compress and seal under very low loads and provide sealing capabilities. The gasket generally includes a spiral wound metal portion and an outer guide ring to limit the compression of the gasket. The addition of flexible graphite to the winding surface and the outer ring surface provides a more durable gasket with low sealing load requirements and elimination of buckling under sealing loads.

U.S. Pat. No. 5,794,946 ('946 Patent), which issued to Owen, discloses a spiral wound gasket. The '946 Patent describes a spiral wound gasket able to compress and seal under various loads and provide sealing capabilities. The gasket generally includes a spiral wound portion and an outer guide ring to limit the compression of the gasket. The spiral winding is formed of interdisposed windings of a metal and an elastomer sealant. The metal winding has a non-planar cross-section to inhibit buckling under compression. The gasket is dimensioned such that the elastomer sealant winding has a width greater than the width of the metal winding which has a width greater than the thickness of the guide ring. In this manner, the sealant is compressed before compression of the metal winding which can be compressed until the outer guide ring is encountered.

U.S. Pat. No. 5,664,791 ('791 Patent), which issued to Owen, discloses a spiral wound gasket. The '791 Patent describes a spiral wound gasket with outer ring also which includes means for preventing buckling of the spiral winding during compression. The outer compression ring provides a compression limit to prevent over-compression of the gasket. Note that prior art with spiral wound gaskets typically contain an outer guide ring. The outside diameter of the outer guide ring typically extends to the inside of the bolt holes and is used for centering the gasket on the flange. The outer guide ring also limits compression on the gasket when the raised face contacts the outer guide ring. The flange faces do not contact the outer ring, only the raised face, and the flange is free to rotate due to assembly and applied loads.

U.S. Pat. No. 5,421,594 ('594 Patent), which issued to Becerra, discloses a corrugated gasket. The '594 Patent describes gaskets having continuous multiple seals created by utilizing a core of functionally corrugated material encapsulated by a graphite material such that an interactive relationship exists between the graphite, the functionally corrugated core, and the surfaces to be sealed.

U.S. Pat. No. 6,318,732 ('732 Patent), which issued to Hoyes, et al., discloses a resilient gasket. The '732 Patent describes a gasket where the resilience is achieved by utilizing springy metal which resists being bent out of its initial shape. The '732 Patent teaches the advantages of a gasketed joint with resilience in maintaining a leak tight joint.

U.S. Pat. No. 5,785,322 ('322 Patent), which issued to Suggs and Meyer discloses a gasket made of a plate having a central opening with an annular region concentric to the gasket opening, the annular region having a plurality of concentric deformable ridges and opposite facing grooves in a first and second surface of the plate. A sealing material overlies the ridges and grooves.

It is known by those skilled in the art that there is increased assembly efficiency and reduced bolt load variation with a stiff metal surface vs. a compliant gasket surface. U.S. Pat. No. 5,278,775 ('775 Patent), which issued to Bible, Column 8, line 41 states that “It may therefore be concluded that an infinitely stiff flange without a gasket would have no interaction whereas a gasketed joint will behave differently with increased flange stiffness.”

United States Patent No. 4,620,995 ('995 Patent), which issued to Otomo , et al., discloses a sheet type gasket and teaches the relaxation properties of sheet type gaskets. Gasket sheets made of a joint sheet have an advantage of better stress relaxation properties; however, they have the disadvantage of poor conformability because of their hard surface material. Moreover, due to insufficient impermeability of the surface material, the mechanical properties of the gasket sheet, such as tensile strength, tear strength and bending strength, are affected adversely. In addition, it has been found that the binder in the surface material disintegrates from chemical attack causing damage to the surface material due to corrosion and/or unwanted adhesion. While the gasket sheets made of a beater sheet have the advantage of better conformability, they show rather poor stress relaxation properties. Surface treatment of the gasket sheet is necessary to improve the stress relaxation properties. Any relaxation of a sheet gasket in a flanged joint will translate into a reduced clamping load and reduced sealing gasket load.

### SUMMARY OF THE INVENTION

The problem addressed is improving the reliability of sealing structures used to join conduits or chamber having a sealing body located about opposing ends thereof and improving the ease of making flanges that join conduits or chamber about such sealing structure. One specific type of sealing structure is in the form of a gasket for use in standard flanges that will solve the leakage problems with Standard ASME B 16 Flanges and improve their pressure ratings with ease of reliable, reproducible assembly. There is the need to solve leakage problems in the field and to increase the pressure ratings of existing flanges for process unit revamps, without replacing the flanges. Pressure rotation, thermal rotation, axial thermal differentials, external loads and moments and the non-linear stress strain characteristics of conventional gasket materials are all issues that lead to leakage. The present invention generally relates to a gasket with compression and rotation control that addresses all of these issues, including increasing the pressure capacity of standard flanges without using special designed backup rings that add to the weight, allowing greater external loads, and greater ability to accommodate thermal differentials. The gasket design may be inserted into a standard flange pair in the field, with or without re-machining of the flange faces. It also enables easier, faster and more accurate assembly. These gaskets usually retain a sealing element that provides the primary resistance to fluid leakage about the gasket. It is often desirable to have the sealing element protected from the inside and/or outside environments.

The invention provides a type of sealing structure adapted to seal the gap between two flange bodies around a chamber or conduit when clamped there between. Such a sealing structure gasket may be used, for example, for sealing the gap between flanges at the ends of pipes or the pipe to nozzle flange on vessels or the body flanges on heat exchangers.

A gasket sealed joint is comprised of the two flange bodies that are joined together around a gasket and fasteners that can carry a tensile load for clamping the two flange bodies and compressing the gasket. The two bodies are conventionally called “Flanges” and the fasteners for clamping the flanges and gasket together are conventionally bolts or bolted clamp arrangements. Although bolts are most common, the flange bodies may be clamped together by any clamping structure that act together with the flange, such as bolts, or independently thereof such as a series of clamps located about the periphery of the flanges and positioned to urge the flange bodies together. Such clamping structures are familiar with those skilled in the art.

The further description of the sealing structure of this invention in the context of a gasket located between two flanges is not intended to limit the application of this invention thereto and the invention and the coverage applies broadly to any type of sealing structure as defined by the claims set forth herein.

The preferred embodiment of the gasket 23 comprises a shape that typically covers the majority of the flange face, comprised of at least one compression element and at least one sealing element. The compression elements are preferably tapered in thickness such that the inside surface is thicker than the outside surface. The compression element preferably possesses an inner compression zone, and an outer compression zone. The sealing element possesses annular sealing zone surfaces and may or may not be tapered in thickness. Typically the outer compression zone will contain holes to allow the bolts to pass through. However, there are special variations to the preferred design that still retain some of the advantages of the preferred design, such as no inner compression zone or a reverse taper to accommodate unusual flange geometries.

The assembly of a joint comprised of two flange bodies and a gasket of this invention is faster, easier and more accurately loaded than conventional gasket sealed joints because of the controlled displacement and stiffness of the assembled joint. The flange bodies will contact either the sealing element or inner compression zone first depending on the taper angle and sealing element thickness. As the assembly load is applied it compresses the sealing element and the inner compression element and causes the flange bodies rotate. Assembly is complete when the compressive load completely compresses the sealing element and when the flange bodies rotate a sufficient amount to have the respective flange faces contact both the inner and the outermost compression zone surfaces that extend completely around the gasket. The stiffness of the compression elements is a function of their material(s) of construction, radial annular area, and thickness. The significant radial contact widths of the compression zone surfaces contribute to the high axial compressive stiffness of the assembled joint.

The flange types most suitable for use with the gasket have a flat sealing surface arrangement. In addition, for these flange types the rotational stiffness characteristics are such that the assembly clamping force as it continues to increase applies its force: first to the annular sealing element of the gasket to bring the adjacent portion of the flange face into contact therewith; secondly to the inner compression zone surface; and finally to one or more additional compression zone surfaces (herein referred to as outer compression and intermediate compression zone surfaces) that extend around the gasket to the outside of the outer compression zone surface. In most typical arrangements, by the time the force becomes applied to the any compression zone surfaces located outside of the inner compression zone it also causes full compression of any sealing element located inboard of the outermost compression element.

However, depending on the specific application, the flange face and the associated gasket may have an arrangement such that the flange face will contact the inner or outer compression elements first depending on the gasket taper angles. A very flexible flange may require a gasket with a greater taper angle. In the case of low pressure applications with high external bending moments a negative taper angle may provide a greater moment capacity with a negative taper angle, where the gasket is thicker at the outside diameter than the inside diameter. The gasket may also be adapted for flange faces with a raised face by incorporating a step change in the gasket thickness to match the raised face. The clamping of the joint together must be sufficient to achieve the full force required to compress the gasket to the required thickness and achieve the required forces on the compression zone surfaces. The joint is properly assembled when the flange rotates sufficiently such that the flange faces contact the outer compression zone surface of the gasket, limiting further rotation, after adequate preload has been applied to the inner compression zone surface and sealing element to resist the axial thrust forces due to pressure plus external loads and the required force to seat the sealing element. In addition the gasket requires sufficient residual force to maintain contact considering relaxation in the joint and all applied loadings, mechanical and thermal. If the flange faces are not parallel to each other, the taper angles on the gasket may be adjusted to accommodate the proper angle between the gasket faces and the flange faces. The gasket can accommodate a different taper angle on each side of the gasket to accommodate different flange designs on each side of the gasket.

The gasket sealed joint is dependent on the gasket design, the flange design and the clamping design. For “Standard Flanges” (eg. flanges to a specific standard such as ASME B 16.5) the gasket is designed to work with the specified flange and bolting. For “Special Flanges” the flange, gasket and bolting are designed to optimally work together. The gasket is able to achieve greater pressure ratings than conventional raised face flanges because of several design advantages. The axial component of pressure is primarily reacted at the inner compression zone surface near the inside diameter close to the line of action of the applied load thereby minimizing the bending moment on the flange due to pressure and external mechanical loads. The primary bending stresses due to pressure and external mechanical loads is also reduced due to the opposing moment from the outer compression element reaction force. The flange rotation due to axial and radial pressure thrusts is also resisted by the gasket compression elements. Higher assembly loads can also be achieved because the flange stresses are displacement limited. The contact of the flange face with the gasket compression surfaces resists rotation of the flange, maintaining compression of the annular sealing element and maintaining bolt displacement. The limited rotation by the gasket also resists rotation and unloading of the annular sealing element due to thermal differentials between the flange neck and ring. The flange rotational stiffness can also accommodate some axial thermal differential between the bolts and flanges without unloading the gasket. The solid intimate contact between the gasket sealing and compression elements and the flange faces makes for more uniform temperatures between the flanges, gasket elements and bolts due to both steady state operating temperatures and transient thermal differential temperatures. The gasket also has a much greater blowout capacity than a conventional gasket design due to the wide radial width, that may extend from the inside diameter to the outside diameter, and a positive taper angle also increases the blowout resistance. The sealing element is also contained and prevented from blowout. The gasket also has a much greater external force and moment capacity than a conventional raised face flange/gasket design due to the wide radial width, that may extend from the inside diameter to the outside diameter creating a high effective moment of inertia. After the flange joint is assembled the typical gasket sealing element is completely contained between the inner and outer compression elements and displacement controlled. Flange rotation is limited by contact with the gasket compression elements. The gasket sealing element will see only very minor changes in compressive stress due to variations in operating pressures, external forces, and temperature differentials. The gasket stress in a conventional raised face design will vary with changes in pressure, external loads, and thermal differentials. This can lead to gasket ratcheting and leakage that is prevented by the gasket design. These features make the flange and gasket sealed joint with a gasket able to withstand greater pressures, external forces and moments, and temperature differentials than a conventional raised face flange joint.

The advantages of a rigid vs. flexible gasket in achieving more uniform gasket stress is well known to those experienced in the art of flange joint assembly. Multiple passes of bolt torque are not required. Residual compression of the outer compression zone surface can be achieved by a specified turn of the nut after contact. All flange and bolt stresses are displacement limited and high flange secondary stresses can be tolerated. Conventional gasket sealed joint assembly is subject to uncertainties due to elastic interaction, requiring multiple passes of bolt torque. Friction also introduces scatter in bolt torque versus load correlations resulting in less accurate assembly stresses. Physical limits on excessive flange stresses are not provided in conventional joints. The gasket design has the advantages of uniform displacement controlled sealing element stresses due to the more rigid compression elements and the advantages of the better sealing characteristics of the softer, more compliant, sealing element.

The gasket prior art describes the advantages of an outer guide ring to limit the compression of spiral wound gaskets, the advantages of joint resiliency and the use of multiple sealing surfaces. The prior art does not address the strength and stiffness of the mating flanges and clamping bolts, rigidity of the assembled joint or limiting and controlling rotation of the flanges. The theory of operation of gasket 23 is that the inner compression element and sealing element are compressed with a load sufficient to “seat” and compress the sealing element and react the axial pressure thrust and the axial component of external loads and moments prior to the flange rotating the amount necessary to make contact with the outer compression zone surface. The residual load on the outer compression zone surface is sufficient to accommodate any relaxation in the joint and maintain contact. The proper assembly load is easily achieved with a gasket with positive taper angle because the joint is assembled when the flange contacting faces make contact with the surface of the gasket at the outside diameter creating “metal to metal” contact. Any additional preload required can be easily applied by the “turn of the nut” method or other methods known to those experienced in the assembly of bolted flange joints. This is easily achieved by an assembler with little training or experience, whereas conventional gasket sealed bolted joints require trained and qualified specialists and require more bolt tightening passes and time to assemble. During the application of external static and dynamic mechanical and thermal loads the gasket compression zone surfaces remain in compression, the flange rotation is fixed and the gasket compression remains unchanged. The axial loads will be reacted by unloading the stiffer compression elements. The unloading of the inner compression element will react with the axial applied loads along a line of action close to the effective line of action of the applied loads thereby greatly reducing the bending moment on the flange as compared with a raised face flange with a conventional gasket.

Maintaining a reliable seal in a gasket sealed joint can be challenging when the operating and loading conditions are severe. Several mechanisms attempt to unload the gasket in a conventional flange joint with a gasket: axial pressure thrust, pressure rotation of the flange, dynamic hydraulic and seismic loads, axial thermal differentials, thermal rotation of the flange, gasket relaxation, and gasket ratcheting. The gasket sealed joint design addresses each of these mechanisms preventing the mechanism from degrading the seal and maintaining pressure rating while being a joint that provides for easy and reliable practical assembly in the field.

Applications and applicable environments for the use of Gasket 23 are summarized in the following discussion. In general, gaskets are used to seal fluid containing equipment together, such as piping, vessels, tanks, reactors, heat exchangers, valves, etc. A plan view of a conventional weld neck flange with bolts, prior to tightening the bolts and rotating the flange, is shown in FIG. 9. The view shows the inside diameter within which the process fluid is typically contained, the pipe wall thickness, where the flange hub joins the flange ring, the bolts with nuts and the flange outside diameter. Cross-sectional view A-A could be FIG. 14. Although conventional flanges are typically subjected to internal pressure, they may also be used in external pressure applications and the gasket 23 is also applicable for external pressure and is protected from over-compression from external pressure. The gasket 23 is intended for use in any application where conventional gaskets are currently used.

The gasket 23 is intended for use with flanges with a “raised face” or “flat face” facing. The flange facing is the surface of the flange to be sealed to a mating flange face. The flanges may be of any type, such as “weld neck”, “slip-on,” “socket weld,” “threaded,” “lap joint,” “reverse,” etc. including any type flange referenced in ASME BPV Code Section VIII, Division 1, Appendix 2. The flange bodies may be circular, elliptical, ob-round, rectangular or any closed shape. Examples of conventional “raised face” and “flat face” type flanges are shown in FIGS. 11 and 12 respectively with flange facings 14 and 15. Conventional sealing elements (commonly referred to as “gaskets”) for a raised face flange and a flat face flange are elements 36 and 34 respectively. The purpose of the “raised face” is to force all of the assembly bolt load into the narrower ring shaped gasket without the flange faces contacting one another. This achieves higher assembly gasket stresses than could be achieved with a “flat face” flange with “full face” gasket because of the very high surface area being compressed in a “flat face” design. However the “raised face” flange will have higher bending stresses in the flange than the “flat face” flange design because contact outside of the “bolt circle” diameter creates a counteracting moment reducing the net bending moment on the flange. Refer to ASME BPV Code Section VIII, Division 1, Appendix 2 for methods to calculate the bending moment on flanges for design. “Flat faced” flanges are typically used in lower pressure applications and where connection to castings is required because of the lower bending stresses. These terms are common terminology for those skilled in the art and are facings covered in flange Standards such as ASME B 16.5. The Gasket 23 has two basic shapes, one where the compression elements have a continuous taper and the mating flange bodies are flat face flanges, such as shown in FIG. 1, and one shape where the compression element is machined to conform to the raised face on the mating raised face flanges, such as shown in FIG. 2. Both design variations are considered the same invention. The basic invention is illustrated by FIGS. 1 and 8 and the variations to the basic invention to address specific requirements are illustrated in the figures. Gasket 23 has the advantages of each conventional flange type and does not have the disadvantages.

Applications and limitations are summarized as follows:
1. The gasket 23 may be used with flanges in accordance with any Flange Standard with “flat face” or “raised face” facings, including ASME B 16.5, ASME B 16.47, ASME B 16.1, ASME B 16.42, MSS Standards, AWWA Standards, etc. (Note that ASME is the American Society of Mechanical Engineers, MSS is Manufacturers Standardization Society, AWWA is American Water Works Association.)
2. The gasket 23 may be used with flanges designed as special in accordance with any set of design rules for flat face and raised face flanges, such as ASME BPV Code Section VIII, Division 1, Appendix 2 or AWWA or published methods for special flange types.
3. The gasket 23 has no limitations on size, either minimum or maximum. Size includes diameter, thickness and width of the gasket, its compression elements, and its sealing elements.
4. The gasket 23 has no limitations on the materials of construction other than the requirement that the stiffness of the sealing element(s) must be less than 0.67 times the stiffness of the compression elements(s).
5. The gasket 23 has a limitation on taper angle of 10 degrees. This is just a practical limit and there is no physical reason why a greater taper angle could not be used.
6. The gasket 23 has no limitations on pressure, either internal pressure or external pressure, and no limitations on temperature, either upper or lower.
7. The gasket 23 may be used in any fluid service.
8. The gasket 23 may be used in cyclic service where the pressure or temperature or both cycles as well as external loadings, such as vibration.
9. The gasket 23 may be used in service where it is subjected to high thermal shock loadings.
10. The gasket 23 may be used in service where it is subjected to high mechanical static or dynamic loads including hydraulic shock loadings, seismic loadings, reverse bending moments, etc.
11. The gasket 23 may be used with flanges on any type of pressurized equipment such as piping, vessels, tanks, reactors, heat exchangers, valves, etc.
12. The gasket 23 may be used in typical operating conditions, such as startup, operation, and shutdown, as well as severe environments. Severe environments may include rapid temperature changes, including thermal shock; dynamic loading due to hydraulic shock from fluid transients or mechanical loads, high external loadings, reversed bending moments, and combined mechanical and thermal loadings.

Flange Joints using gasket 23 has many significant advantages over the same flange joint using conventional gaskets and the following discussion explains those advantages in more detail. One advantage is during the process of assembling the joint. In the field the assembly of bolted flange joints may be performed by plant workers without extensive training. Critical flange joints should be assembled by individuals that are experienced, qualified and certified in the assembly of bolted flange joints. The assembly of the gasket 23 does not require expensive certified assemblers since it is easy to know when the joint is properly assembled since it is designed such that it is properly assembled when the flange facing at the outer edge is compressed to contact the outer compression element. The gasket 23 also enables faster assembly than in a conventional flange joint with conventional gasket because you are compressing the flange faces into the stiffer compression element(s) and those skilled in the art know that it takes more assembly passes (number of times that all of the bolts must be tightened) when compressing a soft element than a stiffer element to properly assemble a bolted flange joint. This is also stated in U.S. Pat. No. 5,278,775 ('775 Patent), which issued to Bible. Therefore the gasket 23 has the advantage of faster and easier assembly by less skilled workers than a bolted flange joint with conventional gasket and the associated cost savings. Another advantage of gasket 23 is that an unskilled assembler cannot damage the flanges due to over-rotation during assembly, since the rotation is controlled. Conventional gaskets in standard “raised face” flanges also provide no such control. Conventional full face gaskets in flat face flanges do prevent flange over-rotation during assembly but have the significant disadvantage of low assembly gasket stress. The gasket 23 overcomes this disadvantage.

The advantage of the gasket 23 over a conventional full face gasket (sealing element) in a flat face flange is that when compressing the full face gasket in a flat face flange, FIG. 11, the gasket (sealing element) has a very wide area therefore the available bolt load is spread over a large area resulting in a very low gasket stress as compared with a conventional raised face design, FIG. 12. Raised Face flanges are commonly used to get higher gasket stresses and therefore are used in more critical applications than Flat Face Flanges. Flat Face Flanges are commonly used in low pressure and lower temperature applications. High pressure and/or temperature applications are more typically raised face flange designs. The problem that the gasket 23 solves is that it achieves the best features of a raised face flange design, high sealing element stress, and the advantages of a flat face flange design such as controlled flange rotation and lower primary flange stresses from pressure and external loads. Displacement controlled stresses and Primary Stresses and their appropriate allowable stress limits are discussed in ASME BPV Code Section VIII, Division 2. The gasket 23 controls flange rotation, better than a flat face flange because the compression zones are relatively rigid, and it provides a high stress on the gasket (sealing element). The taper of the compression elements allows the bolt load to go into the sealing element first until the flange rotates the correct amount which is the load when the flange faces contact the outer compression element. The gasket 23 ends up with a high Sealing load on the sealing element with the flange faces limited from excessive rotation during assembly and operation.

The gasket 23 provides for a fixed controlled displacement on the sealing element during operation. Applied pressure, external mechanical loads and thermal differentials within design limits will not affect the gasket sealing stresses because the displacement on the sealing element is fixed. Conventional Raised Face or Flat Face designs allow the gasket stress to unload when operating loads are applied. Conventional Raised Face or Flat Face designs also allow gasket stress reduction due to ratcheting which is prevented by the gasket 23 with a controlled displacement design. The ratcheting mechanism applied to a gasket compression stress-strain curve results in unloading of the gasket during operation and is illustrated in FIG. 13. The figure is actual gasket compressive stress-strain (displacement) data showing the gasket loading curve with 3 unloading curves from different points on the loading curve. The typical gasket stress-strain curve is much steeper upon unloading than during the loading part of the cycle. If the gasket (or sealing element in the terminology of the gasket 23 application) is operating at a gasket stress level at point A and due to any cause a compressive displacement is applied the gasket stress increases to point B. When the same compressive displacement is removed, the gasket stress will drop to point C on the gasket stress-strain unloading curve. This illustrates a mechanism for unloading a gasket in operation due to “ratcheting” and the example is for an applied displacement of only 0.005 inches. The gasket 23 prevents this type of gasket unloading mechanism from occurring since the displacement on the gasket is fixed during operation. A conventional gasket design does not prevent this unloading mechanism from occurring. A practical example is a plant startup, as the process unit heats up the flange joint heats up from the inside surface and the bolts, which are not in contact with the process fluid and exposed to the outside air, lag in temperature. The cooler bolts squeeze the gasket compressing it more. As the bolts finally catch up in temperature, the warmer bolts will unload the gasket and the ratcheting mechanism described above can unload the gasket. Experience has shown that many flange leaks occur during startup, shutdown or other transient thermal events.

The gasket 23 design provides for more uniform temperature distribution in the assembled flange joint than a conventional raised face flange joint. The tapered compression elements provide intimate contact between the flanges and the compression element which promotes more uniform heat transfer in the flange joint assembly. This results in less temperature differentials between parts of the joint and less potential for leakage due to thermal effects. FIG. 17 illustrates the intimate continuous contact between gasket 23 and the flange bodies 8 and 11 during operation, whereas conventional raised face flange assembly, FIG. 18, illustrates that flange bodies 8 and 11 are exposed to the outside environment on both flange faces and the bolts 24 are also exposed to the outside environment as well as the conventional sealing element 36. If the sealing element contains graphite it will be more susceptible to oxidation with greater exposure to the outside air.

Pressure rotation and thermal rotation are terms that describe effects causing flange rotation which will unload the gasket in raised face flanges with a conventional gasket and unload the inner diameter in conventional flat face flanges with conventional gaskets. These effects are known to those skilled in the art. Pressure causes flange rotation by two effects. Referring to FIG. 18, hydraulic axial force H_{D} 38 creates a bending moment about the centerline of the bolts 7. The second effect is due to the radial pressure component acting on the inside diameter of the flange and neck. The radial pressure thrust causes the thinner flange neck 32 to expand in the radial direction, whereas the much thicker flange ring 30 will have an insignificant expansion in the radial direction. Since the neck 32 and flange hub 31 and ring 30 are connected, the flange ring must rotate to accommodate the expansion of the flange neck. This effect and rotation is illustrated in FIG. 18. Thermal rotation can be described in a similar manner. Since the flange ring is exposed to the outer atmosphere and the internal process fluid is typically at an elevated temperature the flange neck will be close to the internal process temperature and the flange ring will be cooler. Similar to the pressure rotation effect the flange neck will expand radially outward due to thermal expansion and the flange ring will also expand outward but a much smaller displacement since it will be at a cooler temperature. The displaced configuration due to thermal rotation will look very similar to FIG. 18 with the thermal differentials causing flange rotation and the gasket 36 will also be unloaded as illustrated by the reduced gasket sealing force H_{G} 42. FIG. 17 illustrates that the outer compression element resists flange rotation and the sealing element will not unload in the gasket 23 design. There are many other thermal differential temperatures that the flange joint may be subjected to and far too numerous to describe here, however gasket 23 provides features to resist such thermal loadings. For example gasket 23 protects the sealing element from changes in bolt load due to thermal effects since the load is directed into the outer compression element.

Gasket 23 is confined by flange bodies 8 and 11 during operation, as illustrated in FIG. 17. Other wide gasket designs constructed of thermally conducting materials, such as steels may warp during operation at elevated temperature. Gasket 23 is confined and restrained from any thermal warping during operation.

The assembly stresses in the flange are displacement limited in the gasket 23 design. The flange stresses are not displacement limited for applied bolt loads in a raised face flange with a conventional gasket.

The operating net primary load twisting moment and flange stresses are less with a flange with gasket 23 than a conventional raised face flange with a conventional gasket since any flange rotation is counteracted by a reverse moment from contact with the outer compression element.

The gasket 23 sealing element is not unloaded until all the compression zone residual loads are relieved. The conventional gasket in a raised face flange starts unloading as soon as pressure loads are applied.

The gasket 23 can withstand significantly greater pressure, external loads and thermal differentials than a conventional gasket design. The very large area and section modulus provided by the gasket 23 can withstand very high external moment loads. FIG. 7 illustrates the large area available to resist an external bending moment, especially on the compression side.

Gasket 23 may be used in conventional raised face or flat face flange and may increase the pressure rating of the conventional Standard Flange. This is because of the higher sealing element stresses, controlled displacement assembly stresses and reduced operating primary pressure stresses.

### BRIEF DESCRIPTION OF THE DRAWINGS

Other features of my invention will become more evident from a consideration of the following brief description of patent drawings:

FIG. 1 is a depiction of a gasket sealed joint comprised of two flat faced flanges, a gasket 23 with a single annular sealing zone, two annular sealing elements, inner and outer compression zones and clamping of the flanges by bolt fasteners. The two annular sealing elements are located in the single annular sealing zone in two respective annular recesses located on opposing sides of the annular compression element. The annular recesses have a radial width and depth sufficient to contain the annular sealing elements. The first annular sealing element creates a seal with the first body and the second annular sealing element creates a seal with the second body when clamped together. The flanges will be clamped together by bolt fasteners and the bolt holes are illustrated

FIG. 2 is a depiction of a gasket sealed joint comprised of two raised faced flanges, a gasket 23 with a single annular sealing element and inner and outer compression elements. The flanges are clamped together by bolt fasteners and the bolt holes are illustrated.

FIG. 3 is a depiction of a gasket 23 comprised of a single compression element with inner and outer annular compression zones and a single integral annular sealing element and zone. The annular sealing element is integral with the compression element.

FIG. 4 is a depiction of a gasket 23 comprised of a single compression element with inner, intermediate and outer annular compression zones and two (multiple) annular sealing zones each with two sealing elements.

FIG. 5 shows a gasket 23 comprised of a single compression element with a single outer compression zone with an integral sealing element located at the inner surface of the gasket.

FIG. 6 is a plan view of a possible irregular gasket 23 shape, this example being an ob-round shape.

FIG. 7 is a plan view of a typical gasket 23 shape, this example being a circular shape. The figure illustrates the inner 3 and outer 4 diameters, sealing element 1, inner 2″ and outer 2′ compression elements and bolt holes 22. Section B-B is illustrated by FIG. 8.

FIG. 8 is a cross sectional view of gasket 23 with a single sealing element 1 of uniform thickness and inner 2″ and outer 2′ compression elements with a uniform taper. The figure also illustrates the inner 3 and outer 4 diameters and bolt holes 22. This represents section B-B from FIG. 8.

FIG. 9 is a plan view of a flange joint assembly illustrating the inside diameter and outside diameter of the flange and the bolts 24 and nuts 26. Section A-A is illustrated by FIG. 14.

FIG. 10 is a cross sectional view of gasket 23 with a single tapered sealing element 1′″ and inner 2″ and outer 2′ compression elements with a step-wise taper. The figure also illustrates the inner 3 and outer diameters 4 and bolt holes 22.

FIG. 11 is a cross sectional of a conventional raised faced flange joint assembly with a conventional gasket (sealing element) 34 in the assembled condition after tightening of the bolts 24 by turning the nuts 26. The figure illustrates the rotation of the flanges 8 and 11 and the bolts 24.

FIG. 12 is a cross sectional view of a conventional flat faced flange joint assembly with a full face sheet type sealing element (conventional gasket) 34. The figure also illustrates the inner 3 and outer 4 diameters, bolts 24, nuts 26 and bolt holes 22.

FIG. 13 is a stress—strain loading and unloading curve for a spiral wound conventional gasket (sealing element) illustrating that the loading part of the curve has a lower slope (lower modulus) than the unloading curves. The figure illustrates the cycle of gasket sealing stress resulting from an applied displacement and removing the displacement.

FIG. 14 is a cross sectional view of a flange joint assembly with gasket 23 at the point in time when the bolts are tightened by turning the nuts enough to initiate compressive contact by flange faces 14 and 15 on the sealing elements 1. This represents section A-A from FIG. 9.

FIG. 15 is a cross sectional view of the same flange joint assembly with gasket 23 as shown in FIG. 14 at the point in time when the bolts are tightened by turning the nuts enough to compress the sealing elements 1 to the point where flange faces 14 and 15 contact the inner compression zone 2a and the flanges 8 and 11 are rotated from their initial condition.

FIG. 16 is a cross sectional view of the same flange joint assembly with gasket 23 as shown in FIGS. 14 and 15 at the point in time when the bolts 24 are tightened by turning the nuts 26 enough to completely compress the sealing elements 1 to the point where the mating flanges 8 and 11 rotate and flange faces 14 and 15 contact the inner compression zone 2a and the outer compression zone 2b. This is the final assembled condition and illustrates the final rotation of the flanges 8 and 11 and the bolts 24.

FIG. 17 is a cross sectional view of the same flange joint assembly with gasket 23 as shown in FIG. 16, fully assembled and after the application of internal pressure 28 and axial pressure thrust force 38. The deformation of the flange neck 32 and the change in contact forces H_{I} 40, H_{G} 42 and H_{O} 44 due to the application of internal pressure are illustrated.

FIG. 18 is a cross sectional view of a conventional raised face flange joint assembly with conventional gasket, as previously shown fully assembled in FIG. 11, after the application of internal pressure 28 and axial pressure thrust force 38. The deformation of the flange neck 32, flange bodies 8 and 11, and gasket 36 are illustrated along with the change in gasket contact forces HG 42 due to the application of internal pressure. The figure also illustrates the deformation of the bolts 24 due to flange rotation.

### DETAILED DESCRIPTION OF THE INVENTION

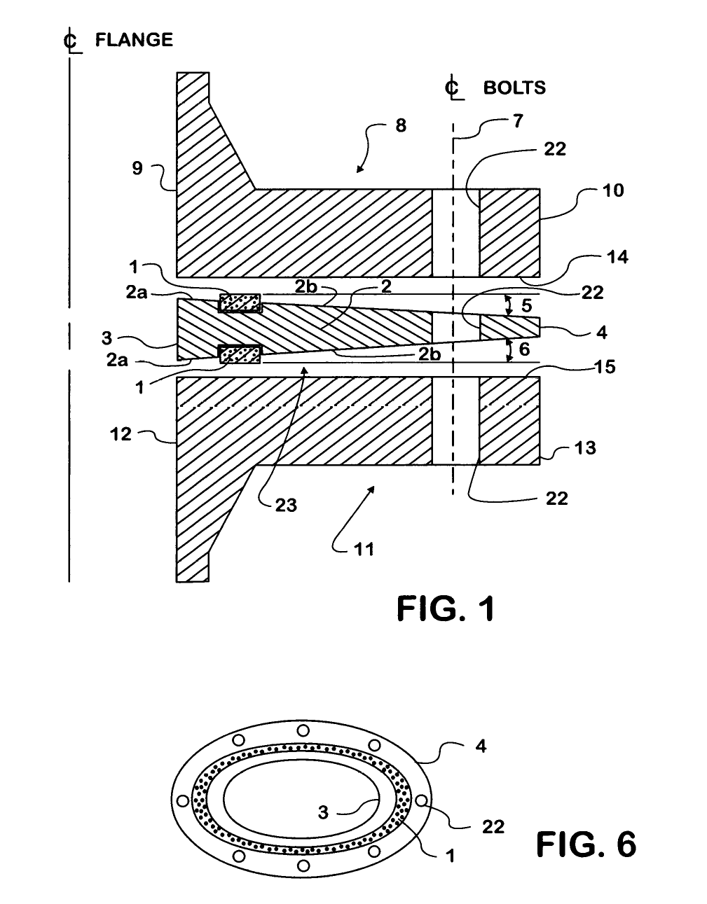

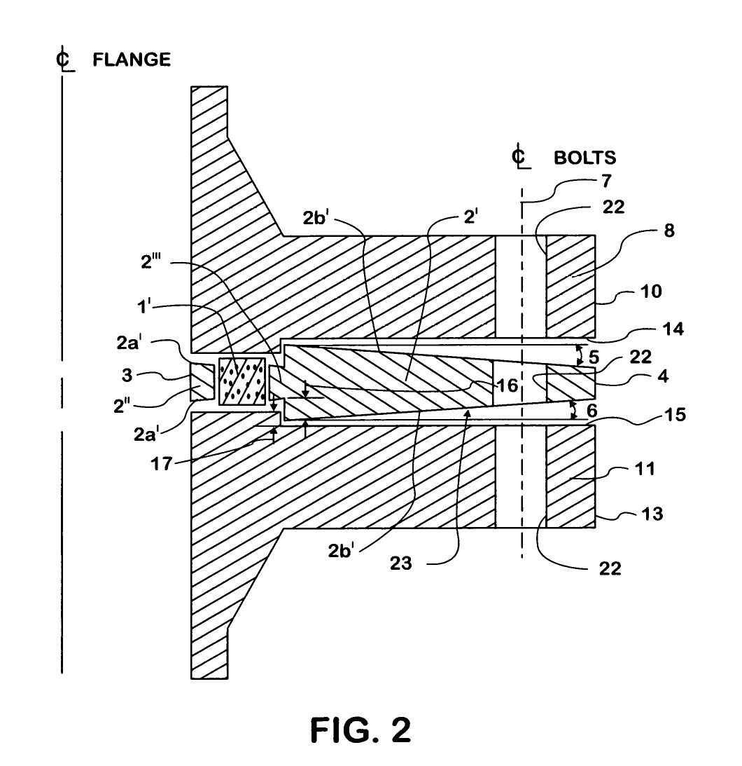

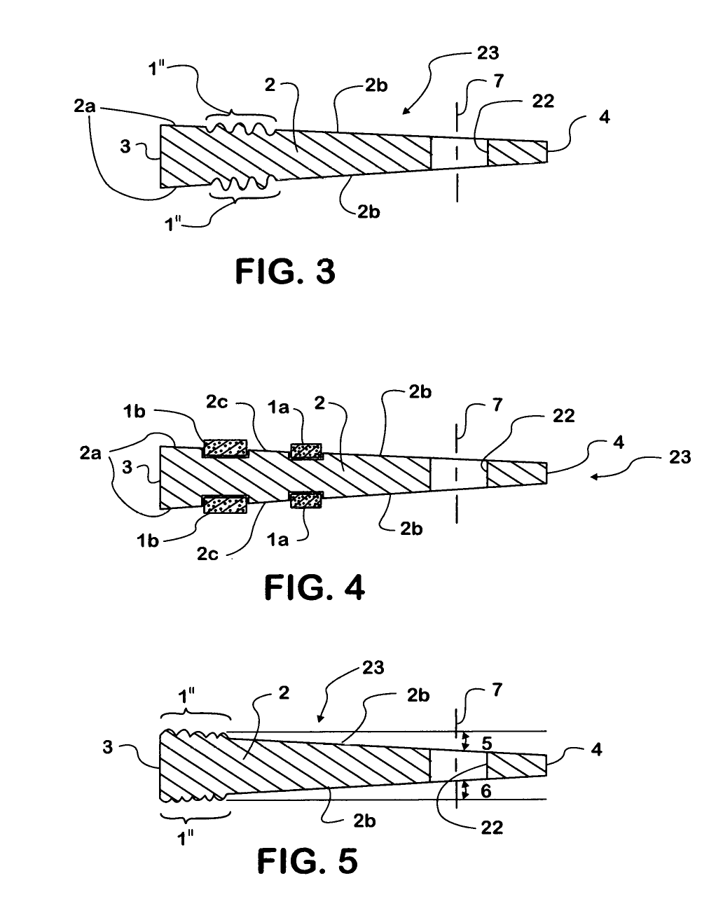

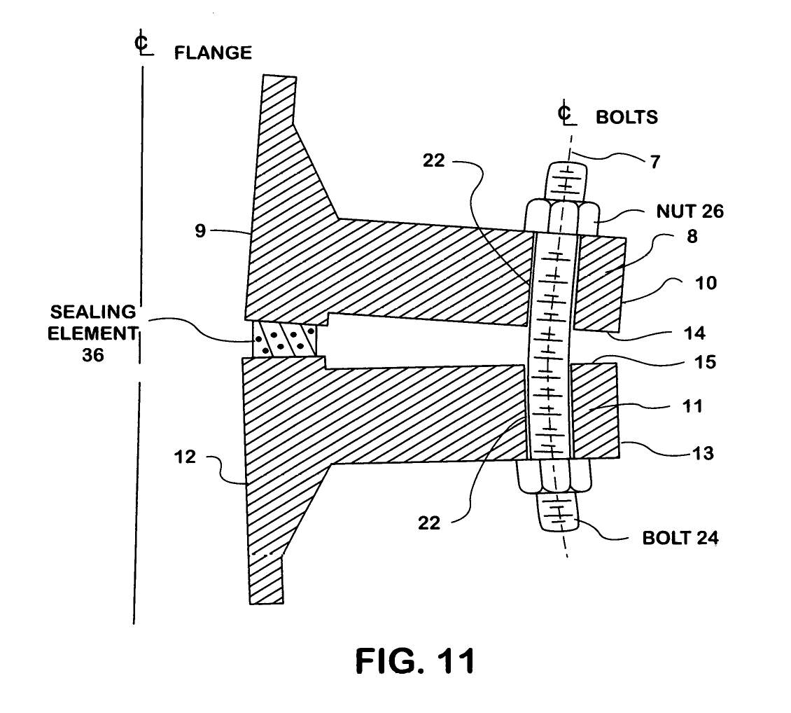

Throughout the description of this invention the following terms and associated definitions apply:
“annular sealing element”: For gaskets with an axisymmetric shape this is an annular shaped element of approximately constant radial width. For gaskets with a non-axisymmetric shape the “annular sealing element” is a shape with an inner and outer surface that approximately follows the same shape as the inner boundary of the gasket with an approximately constant width as measured normal to the inner surface of the “annular sealing element” to its outer surface (eg. the radial distance in the case of axisymmetric geometries). In all cases the “annular sealing element” is comprised of a type of construction and/or material suitable for creating a fluid tight seal, either self sealing or requiring compression and such element(s) may or may not be integral with the compression element. When the sealing element is not integral with a compression element it is comprised of a non-integral sealing element. An example of a non-integral sealing element is spiral windings with filler and a configuration such as shown in FIG. 2. An example of an integral sealing element is a metal zone comprised of concentric serrations with or without a surface coating, such as shown in FIG. 3. The thickness of either may vary in the radial direction or be constant.
“annular sealing zone”: This is an annular shaped zone of approximately constant radial width and encompassing the “annular sealing element(s)” within the zone and the full thickness of the gasket. For gaskets with a non-axisymmetric shape the “annular sealing zone” is a shape as described for the annular sealing element. An annular sealing zone may encompass more than one annular sealing element. The gasket illustrated by FIG. 4 contains two annular sealing zones and four annular sealing elements.
“annular compression element”: For gaskets with an axisymmetric shape this is an annular shaped zone of approximately constant radial width. For gaskets with a non-axisymmetric shape the “annular compression element” is a shape with an inner and outer surface that approximately follows the same shape as the inner boundary of the gasket with an approximately constant width as measured normal to the inner surface of the “annular compression element” to its outer surface (eg. the radial distance in the case of axisymmetric geometries). In all cases an “annular compression zone” is comprised of a type of construction and/or material that has a compressive stiffness greater than the “annular sealing element(s)” of the gasket. The thickness may vary in the radial direction or be constant. An annular compression element may also provide sealing capabilities, although that is not its primary function. A gasket is comprised of one or more “annular compression elements” and one or more “annular sealing elements.” An “annular compression element” may contain multiple “annular compression zones, each loaded to different stress levels.” The gasket of FIG. 1 contains one annular compression element and two annular compression zones, whereas the gasket of FIG. 2 is comprised of two annular compression elements and two annular compression zones.
“annular compression zone” is a zone of the annular compression element with an inner and outer perimeter that approximately follows the same shape as the inner boundary of the gasket with an approximately constant width as measured normal to the inner surface of the “annular compression zone” to its outer perimeter (eg. the radial distance in the case of axisymmetric geometries). An annular compression element is comprised of one or more annular compression zones. The gasket illustrated in FIG. 1 is comprised of an inner compression zone, that extends from the inside diameter of the gasket to the inside diameter of the annular sealing zone , and an outer compression zone that extends from the outside diameter of the annular sealing zone to the outside diameter of the gasket. In the case of multiple sealing elements, there will be intermediate annular compression zones between sealing elements, such as in FIG. 4. The surfaces of the compression zones contact the mating flange faces when the joint is assembled.
“blowout”: This is a term commonly used to describe when the contact forces between the flanges and gasket are reduced and the internal pressure is increased to the level where the gasket is pushed radially outboard until there is loss of pressure containment.
“flanges”: Flanges are bodies with surfaces for contacting the gasket, of a design that allows the flanges to be clamped together compressing the gasket between the flange faces to create a fluid seal and of a design with appropriate structural strength and rigidity to withstand the clamping forces and all imposed loading. The types of flanges include, but is not limited to, Integral, Loose, and Reverse, as described and shown in ASME Boiler and Pressure Vessel Code, Section VIII, Division 1, Appendix 2 and Clamp Type Connectors, including those as described in Appendix 24. However the design shape may be any shape that can clamp and seal the gasket including non-circular, elliptical and rectangular flanges. The ideal embodiment is a flange design with appropriate geometry and rigidity compatible with the gasket shape as described herein.
“flange hub”: the portion tapered in thickness between the flange neck and the flange ring.
“flange neck”: the hollow tubular structure attached to the flange hub, typically by welding.
“flange ring”: the rectangular portion of the flange and typically the most massive portion of the flange. The flange hub extends from the flange ring to attach to the flange neck.
“gasket”: This invention describes a gasket that comprises sealing element(s) and compression element(s). When the term gasket is used herein it includes all elements. Conventional terminology uses the term gasket when referring to sealing elements or sealing elements with compression elements. The term “conventional gasket” refers to these conventional designs.
“gasket sealed joint”: The term “gasket sealed joint” relates to all elements of the joint , which includes the gasket and the mating flange bodies for creating a fluid seal between pressure containing components such as illustrated in FIGS. 11, 12, 16, 17, and 18.
“inside or outside diameter”: The gasket elements typically have an axisymmetric geometry with an inner and outer radius. However, there are cases where the gasket elements are not axisymmetric, such as for elliptically shaped flanges. In those cases when the term inside or outside diameter is used it is referring to the inside or outside perimeter, since it is not a true diameter.
“Kammprofile gasket”: A gasket comprised of a concentrically serrated solid metal core with a soft, conformable sealing material bonded to each face.
“pressure energized sealing element”: Sealing elements where the element deforms under internal pressure creating contact stresses between the element and the mating bodies in excess of the internal pressure thereby maintaining a seal.
“taper angle”: The “first body taper angle” is defined as the angle between a line drawn in a radial plane in the contacting surface of the first body and a line drawn in a radial plane from a point on the surface of the gasket closest to the first body, at the innermost diameter of the innermost compression element, to a point on the surface of the gasket closest to the first body, at the outermost diameter of the outermost compression element. The “second body taper angle” is defined as the angle between a line drawn in a radial plane in the contacting surface of the second body and a line drawn in a radial plane from the surface of the gasket closest to the second body, at the inner diameter of the innermost compression element, to a point on the surface of the gasket closest to the second body, at the outer diameter of the outermost compression element. The first and second body taper angles typically range from zero degrees to less than approximately 10 degrees and preferably from 0.01 to 3 degrees, however it is possible to have a negative taper angle if the mating flanges are tapered an excessive amount. These limits are typical for steel flanges, because there is no limitation on materials, these limits may be greater for low modulus materials such as plastics. This can be addressed for materials other than steel by multiplying the above limits by the ratio of 30×10⁶ psi divided by the modulus of elasticity of the actual flange material in psi units.

FIG. 1 illustrates one embodiment of the gasket of this invention in a gasket sealed joint with an axisymmetric geometry comprising upper and lower flanges, 8, and 11 respectively; the gasket 23 comprised of two annular sealing elements 1, an annular compression element 2 with variable thickness, annular compression zones 2a and 2b; means for clamping the joint together consisting of bolt holes 22 and bolt fasteners centered along centerline 7. Although bolts are the fasteners used to clamp the joint together as illustrated herein, other clamping structures may also be employed such as bolted clamp connectors. The compression element is tapered in thickness with upper taper angle 5 and lower taper angle 6 each forming a frustro-conical surface. Flange 8 has inside diameter 9, outside diameter 10 and flange face 14. Flange 11 has inside diameter 12, outside diameter 13 and flange face 15. The typical and preferred embodiment of the gasket for the gasket sealed joint would be comprised of flanges 8 and 11 with approximately the same inside and outside diameters and similar design, however there are no restrictions on flange inside or outside diameters for the application of the gasket of this invention in a gasket sealed joint other than the gasket inside diameter 3 should preferably be greater than or equal to the greater of the flange inside diameters 9 and 12 and the gasket outside diameter 4 should preferably be less than or equal to the smaller of flange outside diameters 10 and 13. The outside diameter 4 of the gasket should preferably extend beyond the bolt circle as defined by the bolt centerline 7. However some benefits of the gasket design are retained if the outside diameter is equal to the inside diameter of the bolt circle.

FIG. 2 illustrates another variation of a gasket sealed joint comprised of mating flanges 8 and 11 and gasket 23 to be sealed between flange faces 14 and 15. Gasket 23 designed in accordance with this invention is comprised of an annular sealing element 1′ and two annular compression elements comprised of inner compression element 2″ and outer compression element 2′ that define annular compression zone surfaces 2a′ and 2b′ respectively. (The same reference numbers designate like elements in the Figures) The gasket 23 varies in thickness from the inside diameter 3 to outside diameter 4. The compression elements 2″ and 2′ tapered in thickness with upper taper angle 5′ and lower taper angle 6′ each forming a frustro-conical surface. The annular sealing element is not integral with the compression elements and the outer annular compression element 2′ is “stepped” in geometry by a distance 16 to provide a thinner portion 2″' that matches the step distance 17 of flange raised face. The “stepped” geometry may be applied to any gasket design of this invention with any combination of sealing and compression elements.

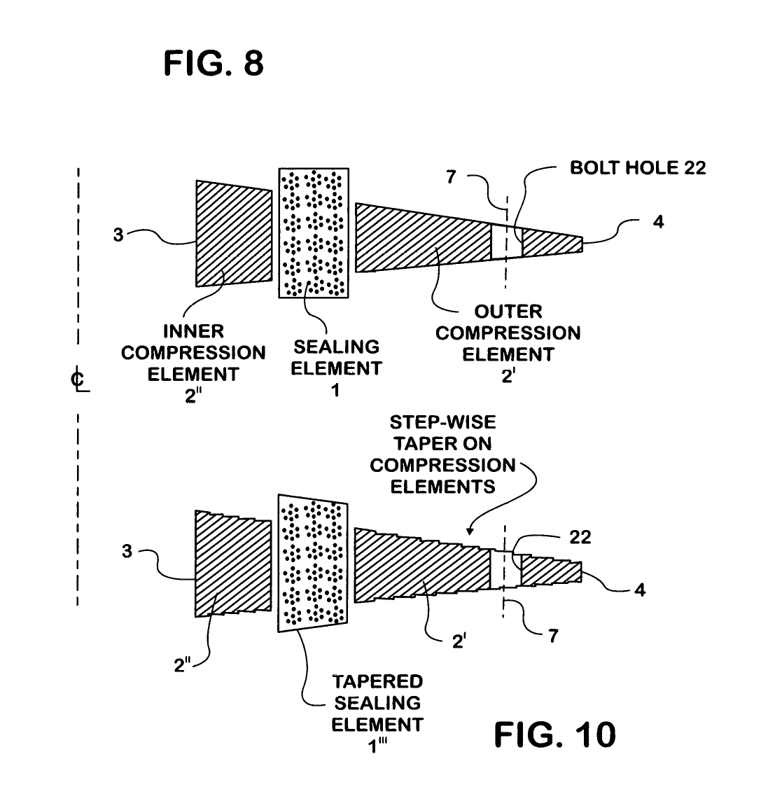

FIG. 3 illustrates another variation of gasket 23 designed in accordance with this invention and comprised of a single annular compression element 2 having inner and outer annular compression zones 2a and 2b respectively, a single annular integral sealing element 1″ comprising a surface of formed serrations, integral with the compression element 2. The gasket 23 again varies in thickness from the inside diameter 3 to outside diameter 4. The compression element is tapered in thickness with upper taper angle 5 and lower taper angle 6, such as illustrated in FIG. 1, each forming a frustro-conical surface. The annular sealing element 1″ is an integral part of the compression element 2 and may or may not be tapered in thickness. The sealing element could be an independent element (such as shown as in FIGS. 1, 2, 4, 8, and 10) or integral with the compression element (FIGS. 3 and 5). The independent sealing element is item 1 in FIG. 1, item 1′ in FIG. 2, items la and lb in FIG. 4, item 1 in FIG. 8, and item 1 in FIG. 10. Integral sealing elements, formed in the body of the compression element, are shown as 1″ in FIGS. 3, and 1″ in FIG. 5. Certain sealing element types lend themselves to different manufacturing methods. “Spiral Wound” sealing elements would be independent sealing elements, however a “Kammprofile” sealing element type could be formed into the compression elements. Note that “Spiral Wound” gaskets and “Kammprofile” are two common types of “gaskets” used in petroleum refineries. Since Gasket 23 includes both sealing elements and compression elements the terminology is different because my “sealing elements” could be “spiral wound” or “Kammprofile” types.

FIG. 4 illustrates another variation of gasket 23 designed in accordance with this invention having: four annular sealing elements, la and lb, each retained at different radial locations along gasket 23, and located on both of its transverse sides; and a single compression element 2 comprised of inner compression zone 2a, outer compression zone 2b and intermediate compression zone 2c. When in use, one or both sides of the intermediate compressions zone 2c may not have compressive contact with the adjacent flange face. The gasket illustrated in FIG. 4 may find preferred application in the handling hazardous fluids.

For the application of handling hazardous fluids or for other purposes, a sensing element may in communication with one or both of the compression zones 2c or a fluid volume confined by volume confined between sealing elements lb and la, respectively. The sealing element may monitor relative or absolute pressure in the confined volume as an indication of leakage or for other purposes.

FIG. 5 shows another variation of gasket 23 having a single unitary compression element 2 containing an integral sealing element 1″ located at the inner surface 3 of gasket 23 and outer compression zones 2b. The compression element 2 tapers in thickness with upper taper angle 5 and lower taper angle 6 each forming a frustro-conical surface. Taper angles 5 and 6 may vary from each other as required to accommodate the mating flanges. This is true of all variations of gasket 23 as illustrated in the figures. Taper angles 5 and 6 are shown for the case when an annular sealing element is located at the inner diameter. This gasket design may be necessary when the application requires the seal to be at the innermost diameter of the gasket.

FIG. 6 shows a plan view of an irregularly shaped gasket 23 having an outer perimeter 4 and an inner perimeter 3. FIG. 6 illustrates one of a wide range of possibilities for the shape of the gasket 23 to which this invention may apply. A gasket of this invention may have irregular convex and concave regions around the course of its inner and outer surfaces; and the shape of inner and outer surfaces of the gasket need not match.

FIGS. 8 and 10 also illustrate other variations of gasket 23. FIG. 8 shows a single sealing element 1 with inner 2″ and outer 2′ tapered compression elements with bolt holes through the outer compression element. FIG. 10 has similar elements as FIG. 8 except that it illustrates that the sealing element 1′″ may be tapered in thickness similar to the compression elements 2″ and 2′ and the compression elements may be formed with a taper in a step-wise manner vs. a continuous taper as shown in FIG. 8. Although a tapered sealing element may be preferred in theory to achieve uniform sealing stress, it is not a significant issue in practice because of the relatively narrow width of the sealing element. A sealing element with uniform thickness will have a greater sealing stress at the outer diameter that could have some advantage. The sealing element is typically easier to manufacture with uniform thickness and no taper. FIG. 8 illustrates a compression element with a continuous smooth taper in thickness and FIG. 10 illustrates a step-wise taper in thickness. The step-wise taper just allows for less expensive manufacturing processes.

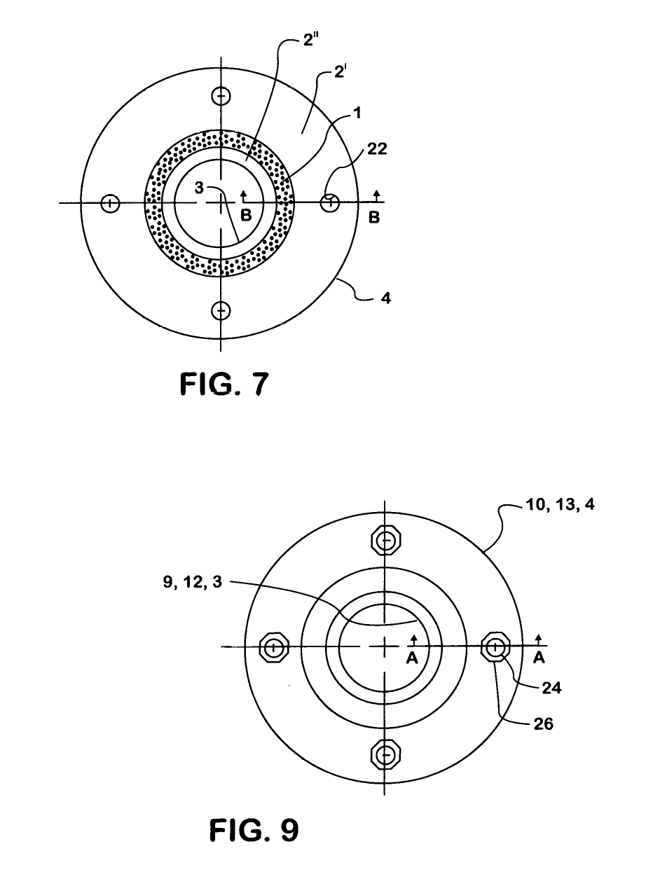

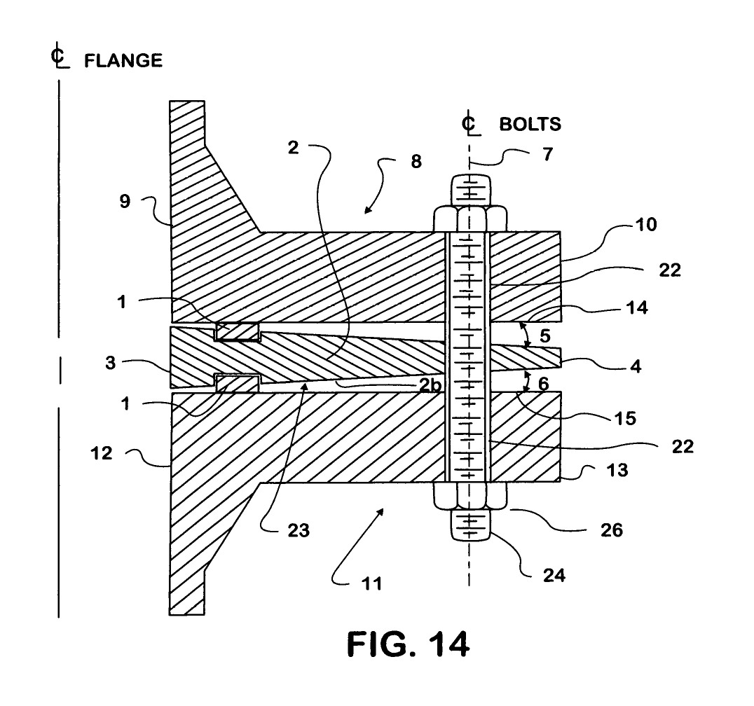

FIGS. 7 and 9 provide plan views of the gasket 23 and flange joint assembly respectively with section lines. The respective cross section views are shown in FIGS. 8 for gasket 23 and FIG. 14 for the flange joint assembly. These figures are included to provide a clear understanding of the geometry. The remaining figures provide clear comparisons between conventional bolted flange joint assemblies and those with gasket 23 in the assembled and operating conditions.

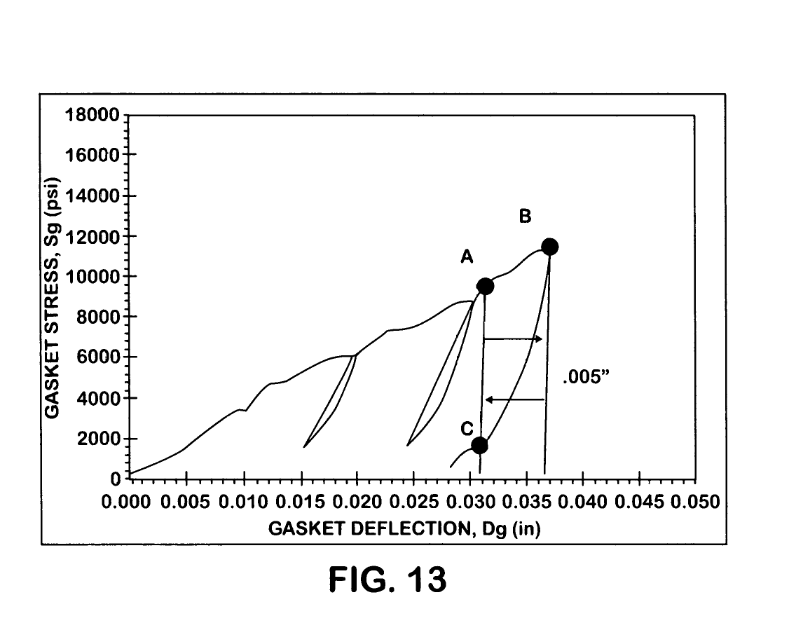

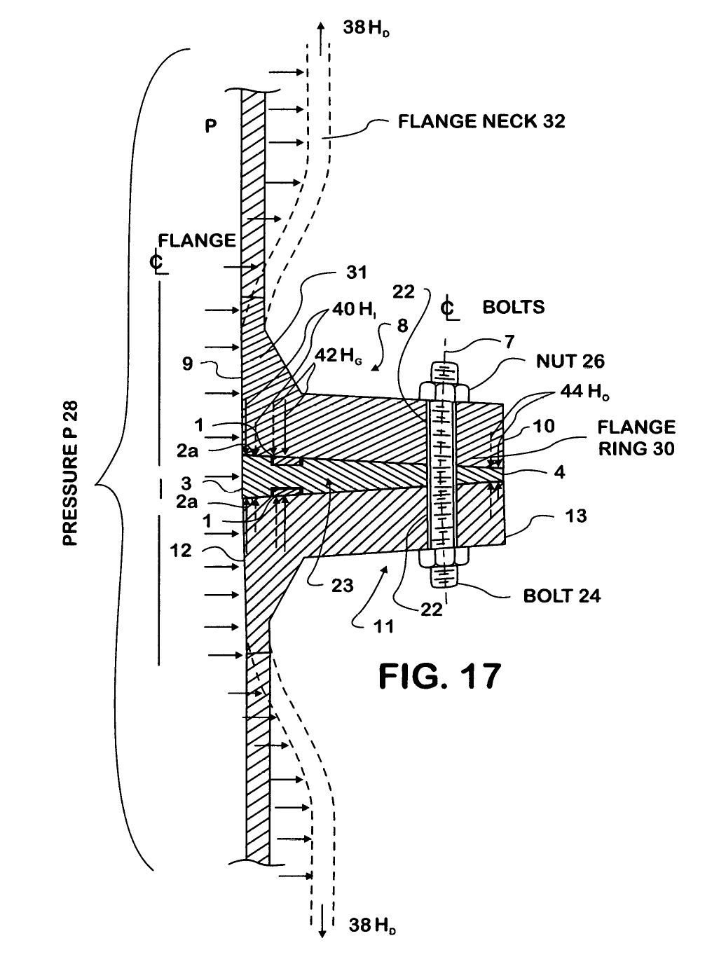

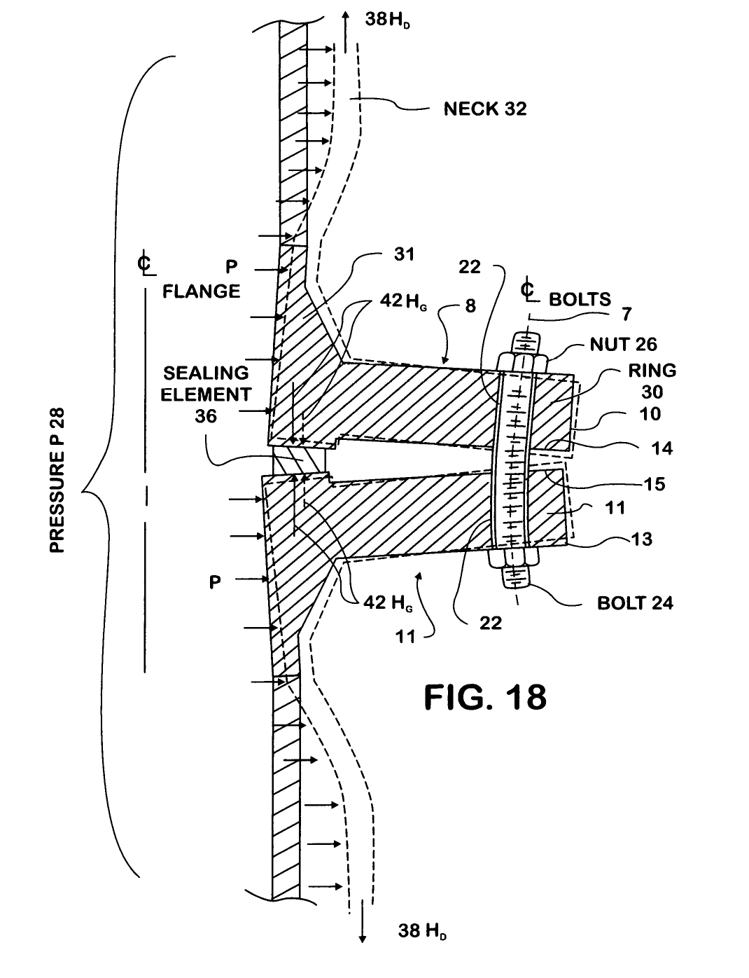

FIGS. 11 through 18 will be used to describe the assembly and operation of conventional flanges with conventional gaskets and the assembly and operation of Gasket 23. The figures shown are for typical weld neck flanges and the discussion of the assembly and operation applies to other flange types as well. A weld neck flange is known by those skilled in the art and is comprised of a flange ring 30, the rectangular portion of the flange and typically the most massive portion of the flange; the flange neck 32, the hollow tubular structure attached to the flange hub 31; and the flange hub which is the tapered portion between the neck and the ring. The flange ring 30, the flange hub 31 and the flange neck 32 are identified in FIGS. 17 and 18.

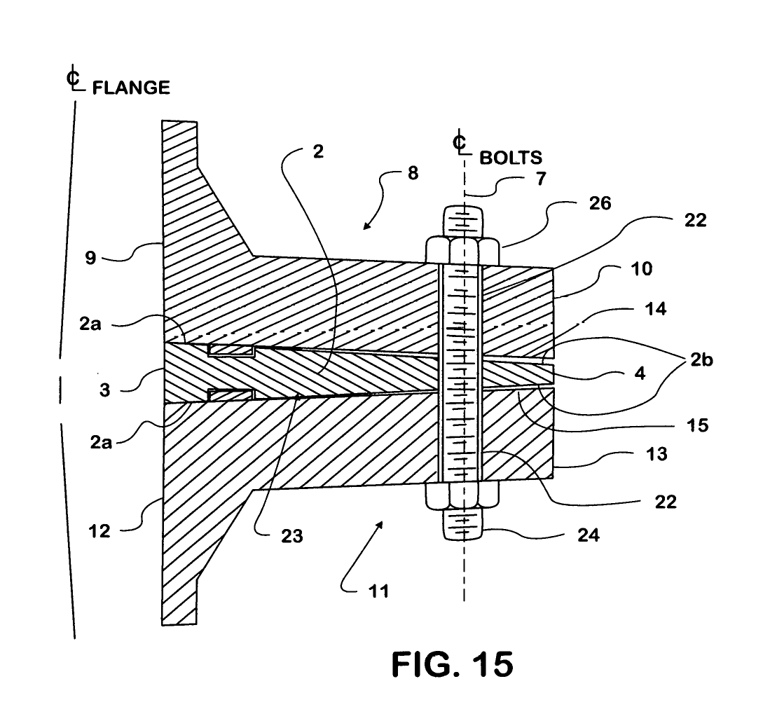

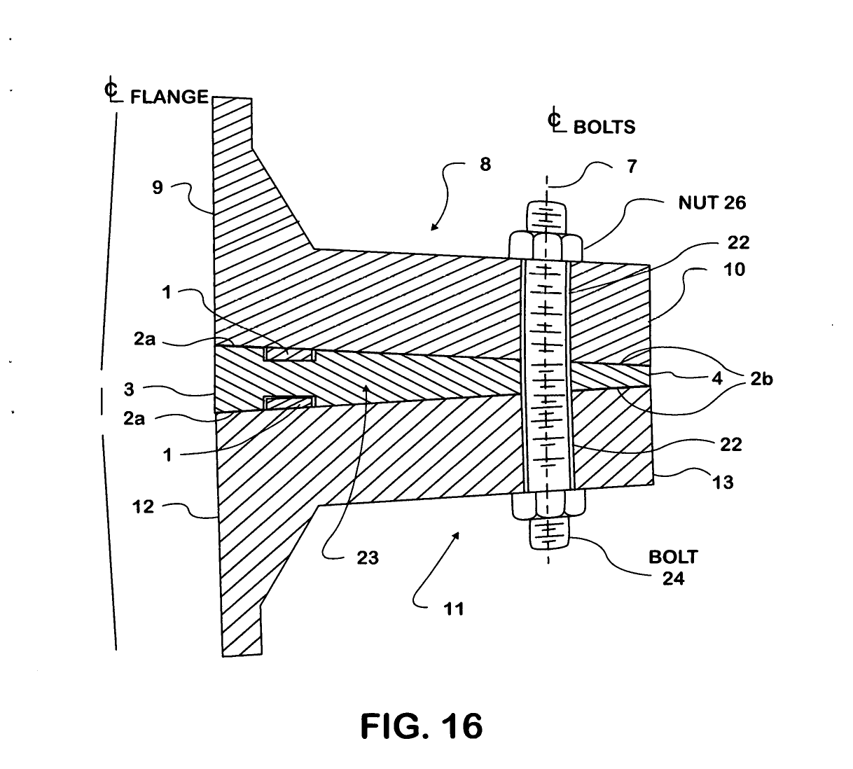

The assembly procedure and operation for a flat faced flange joint with Gasket 23 is illustrated in FIGS. 14, 15, 16 and 17. The assembly procedure and operation discussion also applies to raised face flanges as well. The Flanges 8 and 11 being assembled are flat faced integral weld neck flanges and Gasket 23 is as described in FIG. 1 as having a single compression element 2, two sealing elements 1 and inner 2a and outer 2b compression zones.
The assembly procedure is as follows:
Step 1 is FIG. 14 before the joint is clamped together, the flange bodies 8 and 11 have contacted the sealing elements 1 and the bolts 24 are straight and not yet tightened. FIG. 14 illustrates two flat face flanges with Gasket 23 in between the two flanges. Note that the flat faces on the two flanges are approximately parallel to one another.
Step 2 is illustrated in FIG. 15 during the process of tightening the bolts bringing the two flange faces together and starting to apply load to the gasket and starting to compress the sealing element. The flanges begin to rotate and the flat faces on the two flanges are no longer parallel to one another. The figure illustrates contact of the flange faces of flanges 8 and 11 with the inner compression zone 2a and the compressed portion of the sealing element 1. The flanges have not yet rotated enough to contact the outer compression zone. Since the flanges are not parallel to one another the bolts will bend slightly to accommodate the rotation.
Step 3 is FIG. 16 after the full bolt load is applied to the flanges. The flanges have rotated to contact the outer compression zone of the gasket. The bolt will bend slightly to accommodate the flange rotation. Note that the bolts can withstand a nominal amount of flange rotation and remain elastic and not damage the threads. If the required rotation is too large, spherical washers may be used to minimize bending stress in the bolts. Bolts also are subjected to rotation in conventional raised face flanges with conventional gaskets. The loads on the inner compression element, the sealing element and the outer compression element are illustrated in FIG. 17 for both the assembly and operating cases.

FIG. 17 illustrates a flat faced flange joint with the Gasket 23 in the initial assembled state (solid lines) and the operating state (dotted lines) after internal pressure is applied. The internal pressure has a radial pressure thrust component, P 28, and an axial pressure thrust force, H_{D} 38. The gasket sealing forces, H_{G} 42, are shown as solid lines for the assembly case and dotted lines for the operating case. This illustrates a very small, insignificant, loss of sealing force on the sealing element when typical pressures are applied. The “pressure rotation” is resisted by the outer compression element as indicated by an increase in force H_{O} 44 in the figure. There is also a decrease of the compressive force, H_{I} 40, on the inner compression element. Note that the forces H_{G} 42, H_{O} 44, and H_{I} 40 are shown as concentrated forces for simplicity and clarity on the figure. These forces are actually distributed forces over their respective contact areas. The importance of the forces being distributed over a larger area is significant when reacting large external loads. The small decrease in sealing force on the sealing element vs. the greater decrease in the compressive force on the inner sealing element is because the stiffness, or modulus, of typical sealing elements is much less than that of the compression elements. The modulus of a spiral wound sealing element may be 1/100 of the modulus of a steel compression element. The 0.67 limit on the ratio of sealing element to compression element stiffness would represent an extreme case where there would still be some advantage of the Gasket 23 however the typical practical case would be as previously illustrated. From a practical standpoint the displacement on the gasket 23 sealing element may be considered as “Fixed” and essentially no loss of sealing element compressive load occurs in operation. Compare with FIG. 18 for a conventional gasket.

FIG. 17 may also be used to illustrate a flat faced flange joint with the Gasket 23 in the initial assembled state (solid lines) and the operating state (dotted lines) with operating temperatures applied. Ignore the applied pressure P 28 and force H_{D} 38 and consider the operating configuration of the flange neck as due to thermal growth. The thermal case considered is when the vessel body and flange neck heats up first and the flange ring remains at a cooler temperature. This is the same case as illustrated in FIGS. 18 for a conventional gasket. The gasket sealing forces are shown as solid lines for the assembly case and dotted lines for the operating case. This illustrates that there is no significant loss of sealing force on the sealing element when a typical differential temperature applied. The intimate contact between the gasket compression elements and the flange bodies also allows for more effective thermal conductivity between the flange bodies, the gasket compression elements and the bolts resulting in more uniform temperatures between the bolts and the flanges than in a conventional flange joint with conventional gasket.

The assembly procedure and operation for conventional flange joints with conventional gaskets is illustrated in FIGS. 11, 12 and 18. The assembly procedure and operation discussion addresses both raised face flanges and flat face flanges. FIG. 11 is a conventional assembled flange joint, with conventional raised face flanges and a conventional gasket, after the bolts have been tightened. Note that there is no limit on gasket compression or flange rotation. The gasket could be over-compressed and the flange could be over-stressed and deformed if the individual tightening the bolts over-tightens the bolts. The bolts will also bend to conform to the flange rotation. Note that some conventional gaskets are provided with compression stops to prevent over-compressing the gasket; however they do not limit flange rotation and the inside diameter of the gasket may be stressed lower than desired. Since the amount of flange rotation is not controlled, operating pressure or temperature differentials can cause the flanges to rotate more, potentially causing leakage. However in designs with gasket 23 this additional rotation is prevented and gasket compression is maintained. The metal to metal contact between the compression zones and the flanges prevents additional rotation and provides for more uniform temperatures throughout the flange joint.

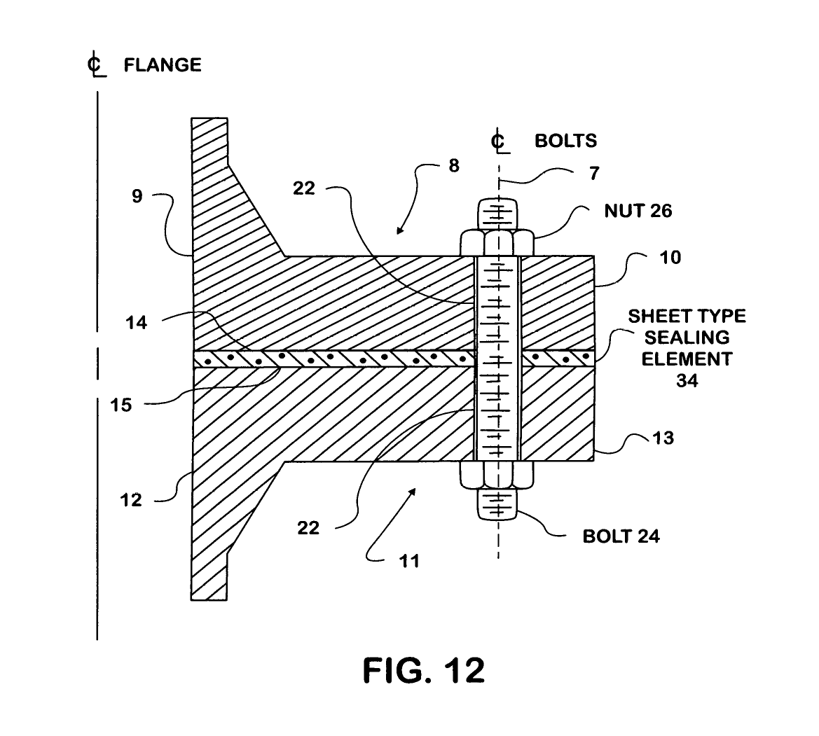

FIG. 12 is a conventional assembled flange joint, with conventional flat face flanges and a conventional gasket, after the bolts have been tightened. Note that the bolt force to achieve the same gasket stress in a flat face flange is much greater than in a raised face flange with the same geometry except for facing. This is due to the much greater gasket area in the flat face design than in a raised face design. This is the function of the raised face, to force all of the bolt load into the narrower gasket on the raised face and the flange outer diameters never touch. This is a disadvantage of a conventional flat face flange design however advantages are that the assembly and operating flange stresses are lower in FIG. 12 vs. FIG. 11 because of the higher flange bending moments in FIG. 11. The flat face flange design also provides a limit on flange rotation limiting unloading of the full face gasket 34 due to pressure rotation and thermal rotation.

FIG. 18 illustrates a conventional raised face flange joint with a conventional gasket in the initial assembled state (solid lines) and the operating state (dotted lines) after internal pressure 28, including the axial pressure thrust H_{D} 38, is applied. The gasket sealing forces H_{G} 42 are shown as solid lines for the assembly case and dotted lines for the operating case. This illustrates the loss of gasket sealing force 42 on the gasket when pressure 28 is applied in a conventional raised face flange joint. The loss of gasket stress is due to flange rotation.

FIG. 18 may also be used to illustrate a conventional flange joint with a conventional gasket in the initial assembled state (solid lines) and the operating state (dotted lines) with operating temperatures applied. Ignore the applied pressure P 28 and force H_{D} 38 and consider the operating configuration of the flange neck as due to thermal growth. Instead of pressure pushing the flange neck out radially the flange neck 32 is at a higher temperature than the flange ring 30 and moves out radially due to thermal growth. The flange neck 32, the hollow tubular structure attached to the flange hub 31, the tapered portion between the neck and the ring, and the flange ring 30, the rectangular portion of the flange, are identified in FIGS. 17 and 18. There are a wide variety of thermal differential temperatures that may be experienced in a bolted flange joint and one common case is when the vessel body and flange neck heats up first and the flange ring remains at a cooler temperature. The gasket sealing forces are shown as solid lines for the assembly case and dotted lines for the operating case. This illustrates the loss of gasket sealing force on the gasket when a differential temperature is applied.

The typical gasket 23 designs for flat face flanges would have a single annular sealing element with two compression elements as shown in FIG. 8 or two sealing elements and a singular compression element as shown in FIG. 1. A typical gasket 23 design for raised face flanges is as shown in FIG. 2. However combinations of multiple annular sealing and compression elements are also acceptable, such as described above. The annular sealing elements may be integral with the compression elements of the gasket as shown in FIG. 3 or non-integral elements such as illustrated in FIG. 2. The overall gasket varies in thickness typically being thicker at the inside diameter and thinner at the outside diameter. FIG. 1 illustrates the gasket with a uniform taper from the inside diameter 3 to the outside diameter 4 with a taper defined by taper angles 5 and 6.

In reference to FIG. 1, the preferred embodiment of the gasket is with a uniform taper and if flanges 8 and 11 are identical, taper angles 5 and 6 will be equal. However, a gasket design with a non-uniform change in thickness from the inside diameter to the outside diameter may also achieve acceptable sealing capability and such designs are discussed further below. Taper angles 5 and 6 depend on the clamping load to fully compress the annular sealing element, all applied loads and the rotational stiffness of flanges 8 and 11 respectively. The preferred embodiment of the gasket sealed joint is as follows: flange faces 14 and 15 will have rotated angles 5 and 6 respectively when the total uniform load provided by the bolt fasteners during assembly of the joint is equal to or greater than the load required to resist the axial pressure thrust and external loads and compress the annular sealing element such that the flange faces 14 and 15 are in contact with the compression elements adjacent to the annular sealing element. It is preferred, but not required, that an annular compression element be inboard of the innermost sealing element to react the pressure thrust load. When flange 8 rotates under bolt load such that face 14 is in contact with the gasket from the inside diameter 3 to the outside diameter 4 the gasket sealed joint has been assembled to the minimum required bolt stress. Additional bolt stress is beneficial in increasing bolt strain to accommodate relaxation of the joint and providing compressive stress to cause frictional resistance to radial movement of the gasket relative to the flange faces for thermal events.

A gasket with non-uniform taper may embody several different designs. A practical embodiment of the gasket is with annular sealing elements with uniform thickness as in a conventional gasket design and uniformly tapered compression elements. Another embodiment of the gasket with non-uniform taper is with compression elements comprised of segments with uniform thickness, stepped to create a cross section of varying thickness with increasing radial dimension. Any combination of tapered or stepped elements may be used to comprise a gasket with varying thickness. The angles 5 and 6 may be approximated by the angle measured from a line drawn from the surface point at the inside surface 3 and the outside surface 4 with a horizontal line.

Flange contacting faces 14 and 15 may also be tapered in a frustro-conical shape and the taper angles on the gasket adjusted accordingly and could be as small as zero. The gasket taper angles 5 and 6 are measured relative to the flange contacting faces 14 and 15 respectively. There may or not be a compression element inboard of the annular sealing element, even the preferred embodiment is with a compression element inboard of the annular sealing elements.

The annular sealing element design preferred embodiment is such that the gasket stress after relaxation in operation is greater than the stress required to maintain a fluid seal with greater than the required tightness. This annular sealing element minimum stress is generally not less than the fluid pressure contained and typically much greater. The required gasket stress levels for specific tightness levels may be estimated by those experienced in the art. The clamping force and flange bodies must be capable of compressing the gasket to the fully compressed thickness. The fully compressed thickness for the annular sealing element is when the flange faces are compressed to contact with the compression elements adjacent to the annular sealing element. The exception is if the gasket is comprised of a single tapered sealing element, in which case the required gasket stress is dependent on the gasket properties and the mechanical and thermal loadings on the joint. The optimum stress on the annular sealing element during assembly of the joint and the minimum required stress on the annular sealing element after the joint has experienced operation conditions for a period of time such that the annular sealing element has fully relaxed, are properties of specific annular sealing elements. The design of annular sealing elements is a specialized art and those experienced in the art can recommend values of annular sealing element stress for assembly, annular sealing element stress-strain properties, short and long time creep and relaxation properties, and leak tightness properties at minimum annular sealing element stress levels.

I claim:

1. A gasket for joining two conduits by contacting and sealing two opposing flange bodies, with raised face or flat face facings over at least a portion of the flange faces, located at the ends of the conduits to form a sealed and load bearing connection of the two conduits along a common axial centerline by the clamping of flange bodies together about a gasket having an elongate hollow tubular shape with an inner perimeter and an outer perimeter, the gasket comprising:
a) an elongate hollow tubular gasket body containing a central opening leading to a central hole, the opening corresponding to the shape of the flange bodies in an assembled condition, and the thickness of at least a portion of the gasket body varies with increasing distance from the centerline;
b) at least one compression element extending around the outer perimeter of the gasket body;
c) at least one compression zone extending to the outer perimeter of the at least one compression element being in direct contact with adjacent faces of the flange bodies when a connection is assembled, and having a predetermined stiffness, wherein any optional compression zones provided would be radially spaced apart from the at least one compression zone;
d) at least one resilient sealing element, either non-integral or integral to the at least one compression element and extending continuously around a perimeter of the gasket body and the at least one sealing element having a stiffness less than 0.67 times the stiffness of the at least one compression zone; and
e) at least one pair of sealing surfaces with the at least one sealing element defining at least one sealing surface that extends around at least a portion of the at least one sealing element and at least one pair of sealing surfaces being in radial alignment over a transverse width of the gasket body and wherein the at least one pair of sealing surfaces contacts adjacent faces of the flange bodies when the connection is assembled.

2. The gasket of claim 1 wherein the at least one sealing element provides sealing surfaces at opposite positions along the radial surface area of the sealing element to provide a pair of sealing surfaces located radially between two compression elements and the gasket retains the sealing element.

3. The gasket of claim 1 wherein the gasket where the at least one compression element retains two sealing elements each located at opposite radial positions between two compression zones and each sealing element provides a sealing surface for contact with one of the opposing flange bodies.

4. The gasket of claim 1 wherein the thickness of at least a portion of the gasket body decreases with increasing distance from the centerline.

5. The gasket of claim 4 wherein at least a portion the thickness of the gasket body decreases in stepwise fashion.

6. The gasket of claim 4 wherein at least a portion of the thickness of the gasket body decreases uniformly.

7. The gasket of claim 1 wherein the gasket has a circular, ellipsoidal, ob-round, rectangular or any closed shape in a plan view.

8. The gasket of claim 1 wherein the at least one compression element retains a first pair of sealing elements located at opposite positions along the perimeter of the gasket body and spaced apart from a second pair of sealing elements located at opposite positions along a perimeter of the gasket body that together divide the compression element into three compression zones.

9. The gasket of claim 1 wherein the at least one sealing element is integral with the at least one compression element and defines sealing surfaces located at opposite radial positions along the compression element and the sealing element divides the compression element into two radially separated compression zones.

10. The gasket of claim 1 wherein the at least one sealing element is integral with the at least one compression element and defines sealing surfaces located at opposite radial positions along the compression element and the sealing element is located at the inner diameter and there is only one outer compression zone.

11. The gasket of claim 1 wherein the gasket body has grooves and lands extending around a perimeter thereof which match grooves and lands in a face of the flange bodies between which the gasket body is clamped.

12. The gasket of claim 1 wherein the at least one sealing element is uniform in thickness and least one compression element has a continuous taper in the radial direction to form a frusto-conical shape having an angle between a radial plane of the compression element and a surface of the compression element of less than 10 degrees and preferably an angle of from 0.01 to 3.0 degrees all multiplied by the ratio of 30×10⁶ psi divided by the modulus of elasticity of the actual flange material in psi units.

13. The gasket of claim 1 wherein the at least one sealing element is tapered in thickness and the at least one compression element has a continuous taper in the radial direction to form a frusto-conical shape having an angle between a radial plane of the compression element and a surface of the compression element of less than 10 degrees and preferably an angle of from 0.01 to 3.0 degrees all multiplied by the ratio of 30×10⁶ psi divided by the modulus of elasticity of the actual flange material in psi units.

14. The gasket of claim 1 wherein the clamping of the gasket and flange bodies together contains the gasket radially and axially and creates intimate contact between the gasket and the connecting flange bodies providing for more uniform heat transfer between the gasket, flange bodies, bolts and the inner and outer diameters of the gasket and flanges as well as reacting any thermal bolt loads through the outer compression element.

15. The gasket of claim 1 wherein the clamping of the gasket and flange bodies together creates contact between the gasket and the connecting flange bodies providing confinement of the sealing element(s) preventing blowout of the gasket as well as preventing ratcheting and unloading of the sealing element(s) due to displacement and flange rotation.

16. The gasket of claim 1 wherein the clamping of the gasket and flange bodies together creates contact between the gasket and the connecting flange bodies providing bearing surfaces resisting flange rotation due to pressure, mechanical and thermal effects and providing a large load bearing area and effective moment of inertia to resist external mechanical, hydraulic, and thermal static and dynamic loads and moments.

17. The gasket of claim 1 wherein the clamping of the gasket and flange bodies together creates contact between at least a portion of the compression elements and sealing elements of the gasket and the faces of the connecting flange bodies.

18. The gasket of claim 1 where the flange bodies being joined include, but are not limited to, integral weld neck, welding neck, slip-on, socket weld, threaded, lap joint, reverse, clamp type, any type flange designed in accordance with or referenced in ASME BPV Code Section VIII or published standards such as ASME B16.5, ASME B16.47, ASME B16.1, ASME B16.42, MSS Standards, AWWA Standards, among others, where the flange bodies may be circular, elliptical, ob-round, rectangular or any closed shape.

19. The gasket of claim 1 wherein there are no limitations on size, materials of construction, internal or external pressure, temperature, fluid service or service conditions beyond industry standards.
